(19) United States
(12) Patent Application Publication
(10) Pub. No.: US 2025/0364632 A1
(43) Pub. Date: Nov. 27, 2025

(54) COOLING AND FIRE EXTINGUISHING DEVICE FOR ELECTRIC STORAGE SYSTEM

(71) Applicant: Chun-Hsiang Hsu, Hsinchu City (TW)

(72) Inventor: Chun-Hsiang Hsu, Hsinchu City (TW)

(21) Appl. No.: 18/872,545

(22) PCT Filed: Jun. 8, 2023
(86) PCT No.: PCT/CN2023/099117

§ 371 Date: Dec. 6, 2024

(30) Foreign Application Priority Data
Jun. 8, 2022 (CN) 202210646636.8

(51) Int. Cl. H01M 10/6568; A62C 3/07; A62C 3/16; A62C 37/40; B60L 53/80; G08B 21/18; H01M 10/613; H01M 10/625; H01M 10/63

(52) U.S. Cl. CPC H01M 10/6568; A62C 3/07; A62C 3/16; A62C 37/40; B60L 53/80; G08B 21/185; H01M 10/613; H01M 10/625; H01M 10/63; H01M 2200/10

(57) ABSTRACT

The present application provides a cooling and fire extinguishing device for electric storage system, disposed in a casing including at least one power supply unit, and a second liquid inlet of the cooling device for the power storage system penetrates an outer side of the casing, and a fluid The pipeline disposed on the inner side of the casing, one end of the fluid pipeline is connected to the second liquid inlet, another end of the fluid pipeline is connected to the at least one power supply unit, and a sensing unit electrically connected to the processing unit, and sense the temperature of the at least one power supply unit to generate a sensing signal, wherein a fluid enters the fluid pipeline from the second liquid inlet, and the fluid passes through the fluid pipeline to the at least one power supply unit.

### FIELD OF THE INVENTION

This invention indicates a cooling and fire extinguishing device for electric storage system, particularly a cooling device capable of transporting liquid through a pipeline connected to an electric energy supply unit.

### BACKGROUND OF THE INVENTION

Along with the evolution, the energy density of energy storage units represented by lithium batteries is massively increasing, which has solved the issue of battery life that has troubled electric vehicles for nearly a century. Emerging electric vehicle brands represented by TESLA have risen up. Automakers are also accelerating the development and production of electric vehicles. Meanwhile, the construction of charging stations, battery exchange stations and fuel cell facilities for electric vehicles, such as hydrogen refueling stations, is also moving forward fast too.

With the development of battery energy storage units and concerns about mineral energy reserves and rising of and oil prices, major automobile manufacturers have begun to make attempts in the field of new energy vehicles, and the industry has gradually introduced the designs of different pure electric cars, motorcycles, and bicycles.

A pure electric vehicle, also known as a battery electric vehicle (BEV), refers to a vehicle that uses a battery to supply power to a motor and is driven by the motor; the power of the battery is supplemented by an external power supply.

The pure electric vehicles do not emit exhaust gas, so they won't pollute the air around the road. Electric motors have excellent low-speed and acceleration capabilities and energy efficiency, and thus the pure electric vehicles can improve efficiency when applied to job-taking vehicles that need to stop and go frequently (buses, garbage trucks and other vehicles with high torque requirements). When a fuel car is parking, the engine still needs to make idle run to avoid stalling, fuel thus is wasted thereof with unnecessary carbon emissions and pollution. Yet, for a pure electric vehicle, when it is parking, the motor is stops completely without unnecessary energy consumption, and can recover kinetic energy to recharge the battery when braking or going downhill, it also can recharge the battery with the kinetic energy without generating waste heat from braking and avoiding parts' wear-out, nor the maintenance requirement; even the private electric vehicles can reduce energy waste and control the environment in crowded cities.

Pure electric vehicles use batteries to provide electric power to the motor, and the motor converts electric energy into kinetic energy to drive the vehicle. The performance of the battery determines the maximum running miles and charging time of the pure electric vehicle; therefore, the industry is gradually developing batteries with higher energy density.

Electric vehicle batteries are characterized by their high power-to-weight ratio, specific energy, and energy density: If the electric vehicle battery is lighter, the weight of the vehicle will be lighter and can improve the performance of the vehicle. Considering its power density, the most common ones are the lithium-ion batteries and lithium-ion polymer batteries. Other batteries used in electric vehicles include lead-acid batteries (full-tank lead-acid batteries, deep-cycle lead-acid batteries, and valve-regulated lead-acid batteries), nickel-cadmium batteries, and nickel-metal hydride batteries, etc.; occasionally zinc-air batteries and molten sodium nickel chloride battery in salt battery ae applied.

Yet, along with the pursuit of higher energy density of the battery, the heat generated by the battery during charging and discharging gradually increases, causing the temperature of the battery to rise continuously, and corresponding temperature control is thus required. If the temperature of the battery is not properly controlled, resulting in external force damage (such as puncture or extrusion) of the battery, the battery is easy to burn or even explode due to high temperature, and due to the high energy density of the battery that continues to generate heat, making it difficult to cool down and extinguish the fire. Therefore, the industry urgently needs to design a fast cooling device to work with the battery-related environment where the energy density is gradually increasing.

According to the aforesaid problems in the prior art, the present application provides a cooling and fire extinguishing device for an electrical storage system, which utilizes a sensing unit to sense the temperature of at least one power supply unit, and generates a sensing signal to the processing unit to correspondingly sends out an alarm signal, and correspondingly injects fluid from the second liquid inlet and the fluid pipeline into at least one power supply unit to quickly cool down the temperature of the power supply unit.

### SUMMARY

A purpose of the present application is to provide a cooling and fire extinguishing device for an electric storage system, which is provided with a second liquid inlet on the casing, thus at least one power supply unit of the casing is connected with the second liquid inlet and the fluid pipeline, and the sensing unit is used to sense the temperature of at least one power supply unit, generating a sensing signal to the processing unit, making the processing unit send out an corresponding alarm signal. When the temperature of at least one power supply unit is too high, the corresponding fluid is sent from the second liquid inlet and fluid pipeline into the at least one power supply unit, using this structure to achieve the effect of rapidly cooling the power supply unit.

To achieve the aforesaid purpose and effect, the present application provides a cooling and fire extinguishing device for an electrical storage system, disposed in a casing, and at least one power supply unit disposed inside the casing. The at least one power supply unit comprising a first liquid inlet. The cooling and fire extinguishing device of the electrical storage system comprising: A second liquid inlet, a fluid pipeline and a sensing unit. The pipeline disposed on the inner side of the casing, one end of the fluid pipeline is connected to the second liquid inlet, another end of the fluid pipeline is connected to the at least one power supply unit, the processing unit disposed on the inner side of the casing, and disposed on one side of the fluid pipeline; the sensing unit disposed on one side of the at least one power supply unit, the sensing unit will sense the temperature of the at least one power supply unit and generates a sensing signal; Wherein, a fluid enters the fluid pipeline from the second liquid inlet and passes through the fluid pipeline to the at least one power supply unit, forming a structure of rapidly cooling down the power supply unit.

In an embodiment of the present application, it further comprising a processing unit, disposed inside the casing; the sensing unit electrically connected to the processing unit; sensing the temperature of the at least one power supply unit and generating a corresponding sensing signal; and the processing unit receives the sensing signal of the sensing unit and sends out an alarm signal.

In an embodiment of the present application, the fluid pipeline further comprising a control valve, the control valve electrically connected to the processing unit, and the processing unit receives the sensing signal of the sensing unit and sends out a control signal to the control valve to control the switch of the control valve.

In an embodiment of the present application, the fluid enters the fluid pipeline from the second liquid inlet, passing through the fluid pipeline to the control valve; after the fluid passes through the control valve, the fluid enters the at least one power supply unit.

In an embodiment of the present application, a fire extinguisher is further included, which communicates with the second liquid inlet.

In an embodiment of the present application, the fire extinguisher transports the fluid; the fluid enters the fluid pipeline from the second liquid inlet, then it passes through the fluid pipeline to the control valve, after that, the fluid passes through the control valve and flows to the at least one power supply unit.

In an embodiment of the present application, the fluid system is water or fire extinguishing agent.

In an embodiment of the present application, the casing disposed on a carrier.

In an embodiment of the present application, the casing is arranged in a power exchange system.

In an embodiment of the present application, a first electrode and a second electrode are equipped at one end of the casing, and the at least one power supply unit electrically connected to the first electrode and the second electrode.

In an embodiment of the present application, the sensing unit senses the gas around the at least one power supply unit and generates the corresponding sensing signal.

### BRIEF DESCRIPTION OF THE FIGURES

FIG. 1: which is a structural schematic diagram of an embodiment of the present application;

FIG. 2A to FIG. 2B: which are schematic diagrams of the operation of an embodiment of the present application;

FIG. 3: which is a schematic diagram of the electrical connection of an embodiment of the present application;

FIG. 4: which is a schematic diagram of a fire extinguisher according to an embodiment of the present application;

FIG. 5: which is a structural schematic diagram of another embodiment of the present application; and

FIG. 6: which is a schematic diagram of the casing electrode of an embodiment of the present application.

### DETAILED DESCRIPTION

To facilitate the review committee members having a further understanding of the characteristics of the present application and the effects it achieves, the following embodiments and accompanying descriptions are provided as follows:

According to the aforesaid problems in the prior art, the present application applies a second liquid inlet equipped on the outside of a casing, making the at least one power supply unit of the casing communicate with the second liquid inlet and a fluid pipeline; then, use a sensing unit to sense the temperature of the at least one power supply unit and generate a sensing signal sent to a processing unit, making the processing unit sends a corresponding alarm signal. When the temperature of the at least one power supply unit is too high, a fluid is sequentially injected from the second liquid inlet and the fluid pipeline into the at least one power supply unit to cool down it. This structure solves the problem that the conventional power supply unit is difficult to cool down and extinguish fire if it is overheated.

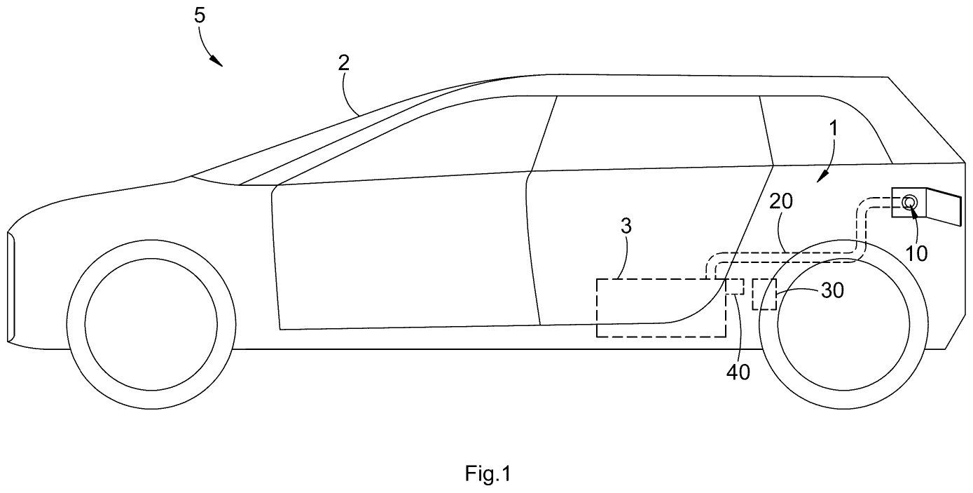

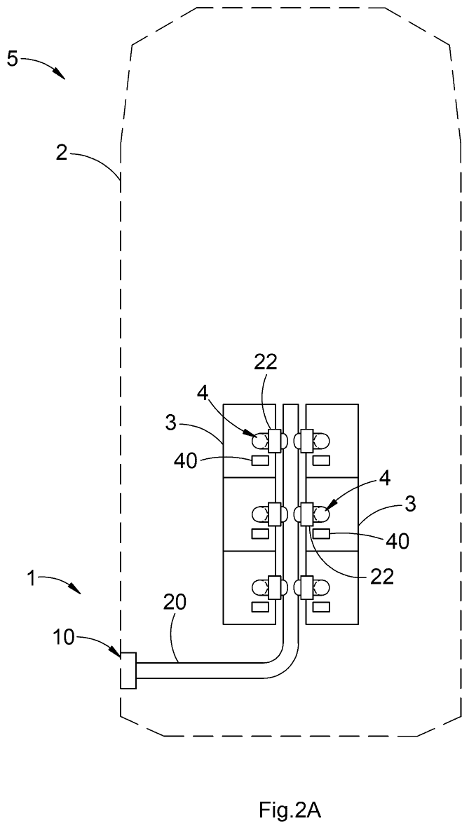

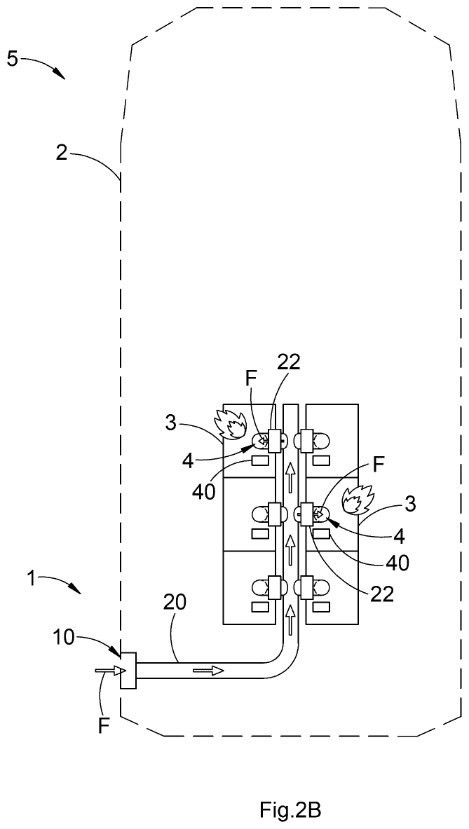

Refer to FIG. 1, which is a schematic structural diagram of an embodiment of the present application. As shown in FIG. 1, this embodiment is a cooling and fire extinguishing device 1 for an electrical storage system, disposed in a casing 2; the at least one power supply unit 3 disposed on one side of the casing 2, and the at least one power supply unit 3 comprising a first liquid inlet 4 (as shown in FIG. 2A). The cooling and fire extinguishing device 1 of the power storage system comprising a second liquid inlet 10, a fluid pipeline 20 and a sensing unit 40. In this embodiment, the at least one power supply unit 3 uses lithium-ion batteries, lithium-ion polymer batteries, lead-acid batteries, nickel-cadmium batteries, nickel-metal hydride batteries, zinc-air battery or sodium nickel chloride battery, yet, this embodiment is not limited to them.

Continuing to above, as shown in FIG. 1, in this embodiment, the casing 2 disposed on a carrier 5, such as the casing of an electric vehicle, electric motorcycle, electric bicycle or electric bus; yet, this embodiment is not limited to them.

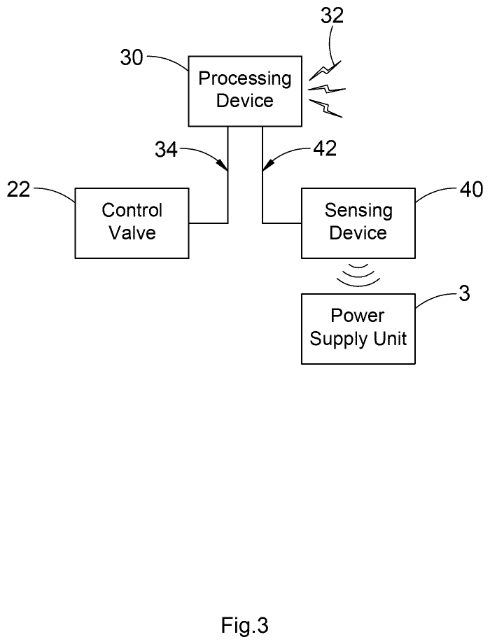

Refer to FIG. 1, FIG. 2A, FIG. 2B and FIG. 3. FIG. 2A and FIG. 2B are schematic diagrams of the operation of an embodiment of the present application, and FIG. 3 is the electrical connection schematic diagram of an embodiment in the present application. As shown in these figures, in this embodiment, the second liquid inlet 10 is installed on the outside of the casing 2; the casing 2 in this embodiment is an example of an electric vehicle, the second liquid inlet 10 passes through one of the outer sides of the carrier; the fluid pipeline 20 disposed on the inner side of the casing 2, one end of the fluid pipeline 20 communicates with the second liquid inlet 10, and another end of the fluid pipeline 20 communicates with the first liquid inlet 4 of the at least one power supply unit 3, making the at least one power supply unit 3 communicate with the outside of the casing 2; the sensing unit 40 disposed on one side of the at least one power supply unit 3, it senses the temperature generated by the at least one power supply unit 3 and generates a sensing signal 42.

Continuing to above, in an embodiment, the sensing unit 40 senses the gas around the at least one power supply unit 3 and generates the sensing signal 42, such as detecting the toxic gas produced by the at least one power supply unit 3.

Continuing to above, in an embodiment, it further comprises a processing unit 30, such as a car computer; the sensing unit 40 electrically connected to the processing unit 30, and the sensing unit 40 will sense the temperature of the at least one power supply unit 3, the generated sensing signal 42 is transmitted to the processing unit 30.

Continuing to above, in this embodiment, the sensing unit 40 can use an infrared temperature measuring device to sense the temperature of the at least one power supply unit 3 and uses the infrared ray to sense the surrounding gas. In an embodiment, the sensing unit 40 will transmit the sensing signal 42 to the processing unit 30 in a real-time matter for the user to confirm the status of the at least one power supply unit 3.

Again, refer to FIG. 2A, FIG. 2B and FIG. 3, as shown in these figures, in this embodiment, the at least one power supply unit 3 is an electric storage unit with high energy density, when the at least one power supply unit 3 is over-discharged or damaged by external force, the at least one power supply unit 3 generates heat and dilates, meanwhile, the sensing unit 40 senses the temperature of the at least one power supply unit 3 and sends out a sensing signal 42 to the processing unit 30. After the processing unit 30 has received the sensing signal 42, it will determine whether the temperature exceeds the preset value or not? If the temperature of the at least one power supply unit 3 exceeds the preset value, the processing unit 30 sends an alarm signal 32. For example, when the temperature of the at least one power supply unit 3 is too high or toxic gas produced by the at least one power supply unit 3 is detected, the processing unit 30 sends out the alarm signal 32, allowing the user (such as a driver or a staff member) to receive the alarm signal of abnormal condition from the at least one power supply unit 3 at the earliest time, stopping the vehicle immediately and opening the fire extinguishing and cooling channel, or the processing unit 30 can send the alarm signal 32 to the remote end, such as the fire control center, to control the injection of the fluid F.

Continuing to above, in this embodiment, when the alarm signal 32 is issued, the user can inject a fluid F from the second liquid inlet 10 into the fluid pipeline 20 correspondingly; after fluid F enters the fluid pipeline 20, the fluid F flows to the at least one power supply unit 3 through the fluid pipeline F, making the fluid F directly contact the at least one power supply unit 3 and cool it down.

Continuing to above, in this embodiment, the fluid F is water, fire extinguishing agent, flame retardant, foaming agent or coolant, used to absorb the massive amount of heat generated by the at least one power supply unit 3, further the fluid F comprising liquid, gaseous, and gel-like objects that can cool down, flame-retardant, and extinguish fire.

Again, refer to FIG. 2A to FIG. 2B and FIG. 3, as shown in the figure, in this embodiment, the fluid pipeline 20 further comprising a control valve 22, which electrically connected to the processing unit 30. When the at least one power supply unit 3 generates heat and dilates, the processing unit 30 receives the sensing signal 42 from the sensing unit 40, and the processing unit 30 sends a control signal 34 to the control valve 22, making the control valve 22 be opened and the fluid F can pass through the fluid pipeline 20 and enter the at least one power supply unit 3. Similarly, when the alarm is not issued, the processing unit 30 sends the control signal 34 to the control valve 22 to close the control valve 22 and now the fluid F cannot enter the fluid pipeline 20.

Continuing to above, in this embodiment, when the control valve 22 is opened, the fluid F enters the fluid pipeline 20 from the second liquid inlet 10, and then the fluid F passes through the fluid pipeline 20 to the control valve 22. After the fluid F passes through the control valve 22, the fluid F enters the at least one power supply unit 3 to absorb the heat of the at least one power supply unit 3 and prevents the at least one power supply unit 3 from igniting or exploding.

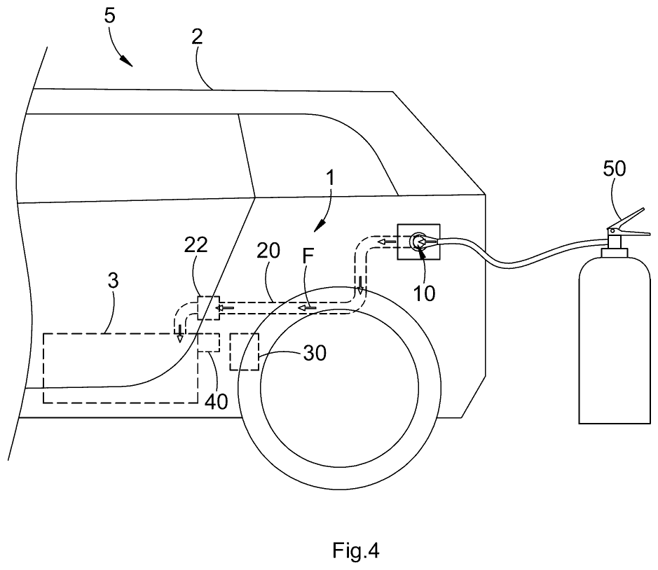

Refer to FIG. 4, which is a schematic diagram of a fire extinguisher according to an embodiment of the present application. As shown in the figure, this embodiment further comprising a fire extinguisher 50, which communicates with the second liquid inlet 10.

Continuing to above, in this embodiment, the fire extinguisher 50 is correspondingly connected to the second liquid inlet 10 and transports the fluid F. The fluid F passes through the second liquid inlet 10 and enters the fluid pipeline 22; after that, the fluid F is conducted to the control valve 22 through the fluid pipeline 20. After the fluid F has passed through the control valve 22, the fluid F flows to the at least one power supply unit 3 to absorb the heat of the at least one power supply unit 3. Other structures and action relationship of this embodiment are identical to the aforesaid embodiment and will not be described again.

Continuing to above, in this embodiment, the processing unit 30 can be correspondingly connected to the fire extinguisher 50, and correspondingly control the fire extinguisher 50 to inject the extinguishing agent into the second liquid inlet 10 while the alarm signal 32 is issued.

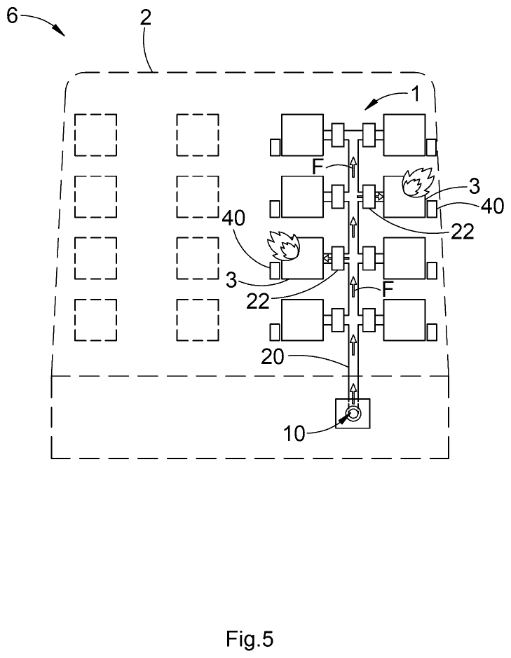

Refer to FIG. 5, which is a structural schematic diagram of another embodiment of the present application. As shown in the figure, this embodiment is a cooling and fire extinguishing device 1 for an electric storage system, disposed in a casing 2; at least one power supply unit 3 disposed on the inner side of the casing 2, and the cooling and fire extinguishing device 1 of the power storage system comprising a second liquid inlet 10, a fluid pipeline 20, a processing unit 30 and a sensing unit 40. In this embodiment, the at least one power supply unit 3 uses a lithium-ion battery, a lithium-ion polymer battery, a lead-acid battery, a nickel-cadmium battery, a nickel-metal hydride battery, a zinc-air battery or a sodium-nickel chloride battery, yet, this embodiment is not limited to them.

Continuing to above, as shown in FIG. 5, in this embodiment, the casing 2 is set in a power exchange system 6, such as the protection casing of a power exchange system, energy storage device, energy storage cabinet or energy storage system. Other structures and action relationship of this embodiment are identical to the aforesaid embodiment and will not be described again.

Continuing to above, the battery exchange system 6 refers to that when the battery of the carrier is charged, the battery is not loaded on the carrier, instead, it is charged on a shelf or a storage cabinet, etc., and the battery exchange system is also prepared for replacement from other carrier with charged battery, carrier thus can continue to operate by the quick replacement.

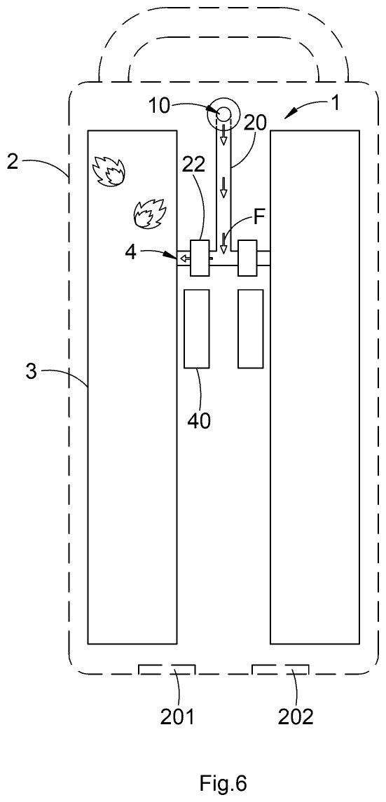

Refer to FIG. 6, which is a schematic diagram of the casing electrode of one embodiment of the present application. As shown in the figure, this embodiment is a cooling and fire extinguishing device 1 for an electrical storage system, disposed on a casing 2; at least one power supply unit 3 disposed on an inner side of the casing 2. The cooling and fire extinguishing device 1 of the power storage system comprising a second liquid inlet 10, a fluid pipeline 20, a processing unit 30 and a sensing unit 40. In this embodiment, the at least one power supply unit 3 uses a lithium-ion battery, a lithium-ion polymer battery, a lead-acid battery, a nickel-cadmium battery, a nickel-metal hydride battery, a zinc-air battery or a sodium-nickel chloride battery, yet, this embodiment is not limited to them.

Continuing to above, as shown in FIG. 6, in this embodiment, a first electrode 201 and a second electrode 202 are arranged at one end of the casing 2, and the at least one power supply unit 3 electrically connected to the first electrode 201 and the second electrode 202; the first electrode 201 and the second electrode 202 are disposed on the casing 2 to form an electrical storage device, such as an industrial battery, a vehicle battery or a battery for battery-exchange station; further electrical storage devices can be disposed inside the electric carrier, the effect of quick battery replacement is achieved. Other structures and action relationship of this embodiment are identical to the aforesaid embodiment and will not be described again.

To sum up, the present application provides a cooling and fire extinguishing device for an electrical storage system, which is provided with a second liquid inlet on the casing (such as a carrier, a battery-exchange station), making the at least one power supply unit contained in the casing, the second liquid inlet and the fluid pipeline are connected. Meanwhile, the sensing unit is used to sense the temperature change of the power supply unit to continuously monitor the operating status of the power supply unit, making the processing unit sends an alarm signal corresponding to the signal of the sensing unit. When the temperature of the power supply unit is too high, the fire extinguishing device connected to the user or the processing unit should inject the fluid from the second liquid inlet and the fluid pipeline into the power supply unit; thus, the structure can quickly transport the fluid to the power supply unit and quickly absorb the heat of the power supply unit, and further prevent the power supply unit from burning, and achieve the effect of fire extinguishing, which can solve the burning or explosion of conventional battery pursuing higher energy density after being damaged by external forces (such as being pierced of squeezed), as well as the fire caused by the heat of battery under consecutive high-energy-density that is difficult to cool down and extinguish therewith.

Therefore, the present application is actually an innovative and advanced one that can be used in industry; it should meet the patent application requirements specified in the ROC Patent Act. We thus issue the patent application according to the Patent Act and anticipate your sooner approval.

From above, the statements stated above are only the preferred embodiments of the present application; all the equivalent changes and modifications made according to the scope of the patent application of the present application should belong to the scope of coverage in the present application.

What is claimed is:

1. A cooling and fire extinguishing device for an electrical storage system, which is disposed inside a casing, at least one power supply unit disposed inside the casing; the at least one power supply unit comprising a first liquid inlet, and the cooling and fire extinguishing device for an electrical storage system comprising:
a second liquid inlet, passing through the outer side of the casing;
a fluid pipeline, disposed inside the casing; one end of the fluid pipeline communicates with the second liquid inlet, and another end of the fluid pipeline communicates with the first liquid inlet of the at least one power supply unit; and
a sensing unit, disposed on one side of the at least one power supply unit; the sensing unit senses the temperature of the at least one power supply unit and generates a sensing signal;
wherein, a fluid enters the fluid pipeline from the second liquid inlet, and the fluid passes through the fluid pipeline to the at least one power supply unit.

2. The cooling and fire extinguishing device of the power storage system of claim 1, further comprising a processing unit, disposed inside the casing; the sensing unit electrically connected to the processing unit, and the sensing unit senses the temperature of at least one power supply unit and generates a sensing signal; the processing unit receives the sensing signal of the sensing unit and sends out an alarm signal.

3. The cooling and fire extinguishing device of the electrical storage system of claim 2, wherein the fluid pipeline further comprising a control valve; the control valve electrically connected to the processing unit, and the processing unit receives the sensing signal of the sensing unit and sends a control signal to the control valve to control the switch of the control valve.

4. The cooling and fire extinguishing device of the electrical storage system of claim 3, wherein the fluid enters the fluid pipeline from the second liquid inlet and passes through the fluid pipeline to the control valve; after the fluid passes through the control valve, the fluid enters the at least one power supply unit.

5. The cooling and fire extinguishing device of the power storage system of claim 4, further comprising a fire extinguisher connected to the second liquid inlet, wherein the fire extinguisher transports the fluid, and the fluid enters the fluid pipeline from the second liquid inlet, and passes through the fluid pipeline to the control valve; after the fluid passes through the control valve, the fluid flows to the at least one power supply unit.

6. The cooling and fire extinguishing device for an electrical storage system of claim 1, wherein the fluid is water, fire extinguishing agent, flame retardant, foaming agent or coolant.

7. The cooling and fire-extinguishing device for an electrical storage system of claim 1, wherein the casing disposed on a carrier.

8. The cooling and fire-extinguishing device for an electrical storage system of claim 1, wherein the casing disposed on a battery-exchange system.

9. The cooling and fire extinguishing device for an electrical storage system of claim 1, wherein a first electrode and a second electrode are arranged at one end of the casing, and the at least one power supply unit electrically connected to the first electrode and the second electrode.

10. The cooling and fire extinguishing device for an electrical storage system of claim 1, wherein the sensing unit senses the gas around the at least one power supply unit and generates the sensing signal.
